(19) United States
(12) Patent Application Publication
(10) Pub. No.: US 2015/0194846 A1
(43) Pub. Date: Jul. 9, 2015

(54) STATOR FOR AN ELECTRICAL MACHINE, ELECTRICAL MACHINE, AND METHOD FOR ASSEMBLING AN ELECTRICAL MACHINE

(71) Applicant: GKN Sinter Metal Holdings GmbH, Radevormwald (DE)

(72) Inventors: Thomas Pütz, Grafschaft (DE); Rainer Schmitt, Wachtberg (DE); Ümit Aydin, Wachtberg (DE); Antonio Casellas, Siegburg (DE)

(21) Appl. No.: 14/419,017

(22) PCT Filed: Jul. 31, 2013
(86) PCT No.: PCT/EP2013/002261

§ 371 Date: Feb. 2, 2015

(30) Foreign Application Priority Data
Aug. 3, 2012 (DE) 10 2012 015 210.8

(51) Int. Cl. H02K 1/14; H02K 15/02

(52) U.S. Cl. CPC H02K 1/145; H02K 15/02

(57) ABSTRACT

The invention relates to a stator for an electrical machine having at least one rotor. The stator is formed as a body provided with at least one opening and having at least one ferromagnetic material. The stator also has at least one region designed as a stator pole carrier, which surrounds a central axis of the stator at least partially, at least one first stator pole with at least a first edge and a second edge, and at least one second stator pole. The stator poles are preferably aligned substantially facing along a radial direction, arranged directly or indirectly on the stator pole carrier. The invention also concerns an electrical machine having at least one stator pair having a first stator and a second stator. Moreover, the invention concerns a method for assembling an electrical machine.

The invention relates to a stator for a electrical machine, which can be assembled, having at least one rotor, wherein the stator is implemented as a disk provided with at least one breakthrough. Furthermore, the invention relates to an electrical machine and a method for assembling a tubular electrical machine.

Constructing electrical machines from a rotor, stators enclosing the rotor, and a winding enclosing the rotor, usually made of copper wire provided with insulation material, is known. Transverse flux machines are an example of such electrical machines. However, such electrical machines can have the disadvantage that the power density is reduced in relation to a theoretical optimum value because of the construction. The reasons for this can be, inter alia, that the windings have winding heads and/or can originate in manufacturing-related tolerances.

The object of the invention is to increase the power density of such electrical machines.

The object is achieved with a stator for an electrical machine, which can be assembled, having the features of claim 1, with an electrical machine having the features of claim 12, and with a method for assembling an electrical machine having the features of claim 16. Further advantageous embodiments and refinements are set forth in the following description. One or more features of the claims, the description, and also the figures can be linked with one or more other features therefrom to form further embodiments of the invention. In particular, one or more features from the independent claims can also be replaced by one or more features from the following description. The proposed subject matter is only to be interpreted as a first draft for formulating the subject matter, without restricting it thereto, however.

A stator is provided for an electrical machine, which can be assembled. The electrical machine is to have at least one rotor in this case. It is provided that the stator is implemented as a body provided with at least one breakthrough, wherein the stator comprises at least one ferromagnetic material. Furthermore, it is provided that the stator has:
at least one region implemented as a stator pole carrier, which at least partially encircles a central axis of the stator,
at least one first stator pole having at least one first flank and one second flank, and
at least one second stator pole.

In this case, the stator poles are arranged directly or indirectly on the stator pole carrier.

In one embodiment of the stator, it can be provided that the region implemented as the stator pole carrier completely encircles the central axis of the stator.

In one embodiment, it is provided that the stator poles are arranged on the stator pole carrier oriented pointing essentially along one radial direction.

The concept of the electrical machine refers, for example, to a machine which converts electrical energy into mechanical energy or mechanical energy into electrical energy. For example, such an electrical machine can be a motor and/or generator. Another example of an electrical machine is, for example, a transformer for exclusively converting electrical energy.

It can be provided, in particular, that the electrical machine is a transverse flux generator. Furthermore, it can be provided that the electrical machine is a transverse flux motor.

It is provided, in particular, that the stator is provided as a stator for an electrical machine in the implementation of an electrical machine for converting electrical energy into mechanical energy. In particular, it is provided that the stator is provided as a stator for a rotating electrical machine, which is provided for transforming electrical energy into a rotational movement. However, it can also be provided that—as a limiting case of a rotating machine having an infinitely large radius of curvature—the stator is provided as a stator for an electrical machine having translational movement, as a so-called “electrical linear motor”.

The term rotor can refer, for example, to a disk-shaped body, which is releasably or non-releasably connected to a shaft. The rotor can be embodied in this case, for example, as a disk having a circular footprint, on which a shaft is arranged at a right angle to the surface of this footprint.

The stator is provided as a body provided with a breakthrough. In this case, a breakthrough refers to a hole which passes through the body completely from one side to the other side. The breakthrough is used in this case, on the one hand, for the potential operability of the shaft he shaft and, on the other hand, for separating the at least one first stator pole from the at least one second stator pole. It can furthermore be provided that the stator has at least two breakthroughs. In one embodiment, it can be provided that the body is implemented as a disk-like body. An implementation as a disk-like body refers in this case to a body which has different orders of magnitude of the extension in two directions of space orthogonal to one another. For example, it can be provided that the body is implemented as a disk-like body having an essentially circular footprint. It can be provided, in particular, in this case that the height of the body is less than the radius of the disk-like body. The designation of a disk-like implementation refers in this case to the fact that an outer lateral surface and the delimitation lines thereof describe a disk-like body; however, this can also include the arrangement of further structures and/or breakthroughs in an interior of the body.

The term ferromagnetic material refers to materials which have a significant ferromagnetic susceptibility, which is significantly greater than 1. In particular, ferromagnetic materials can comprise iron, nickel, cobalt, or alloys which include iron, nickel, and/or cobalt. Further examples are, for example, ferritic steels and also non-sintered and/or sintered ferromagnetic materials. The stator in this case can have a ferromagnetic material or also can have more than one ferromagnetic material. In this case, different ferromagnetic materials can be arranged as a homogeneous or heterogeneous mixture, however, the stator can also comprise an irregular or regular arrangement of ferromagnetic materials and/or ferromagnetic and non-ferromagnetic materials.

The term stator pole carrier refers to a region of the stator on which an arrangement of the stator poles is provided. It can be provided in this case, for example, that a circumference of the stator functions as the stator pole carrier. It is provided that the stator poles are arranged on the stator pole carrier and oriented away therefrom. In this case, it is provided that the stator poles are oriented pointing essentially along one radial direction. The concept of an orientation oriented essentially along one radial direction includes, in particular, that fact that the stator poles comprise at least regions which are oriented toward the central axis of the stator and/or the stator poles comprise at least regions which are oriented pointing away from the central axis of the stator. For example, it can be provided that a number of stator poles is oriented essentially toward the central axis of the stator and a number of further stator poles is oriented essentially away from the central axis of the stator. Furthermore, it can be provided that all stator poles which the stator comprises are oriented essentially toward the central axis of the stator. In a further embodiment of a stator, it can be provided that all stator poles are oriented pointing away from the central axis of the stator. In one embodiment of the stator as a body having a circular footprint, the central axis of the stator corresponds to the rotational axis of this body. In cases in which the stator has no circular footprint, it can be provided that the central axis is implemented as the center of gravity, for example, as the geometrical center of gravity, of the footprint of the stator.

It is provided that the stator poles are arranged on the stator pole carrier. In this case, the stator poles can be arranged directly on the stator pole carrier, for example, however, it can also be provided, for example, that the stator poles are arranged by means of an intermediate region or multiple intermediate regions on the stator pole carrier. This intermediate region can differ, for example, in terms of a cross section and/or a material, from the then adjoining stator pole and/or stator pole carrier. An arrangement of the stator poles on the stator pole carriers can be provided in this case as integrally joined or non-integrally joined.

It can furthermore be provided that the stator is implemented as a stator for an electrical machine which can be reversibly assembled.

In a further embodiment of the stator, it is provided that the first stator pole is asymmetrical to each plane containing the central axis of the stator, and curves essentially progressively away from this plane with increasing distance from the stator pole carrier.

Such an asymmetrical configuration of a stator pole, multiple stator poles, and/or all stator poles has, inter alia, an impact on the torque curve during respective revolutions of the rotor of an electrical machine. It is therefore possible, for example, to tailor a torque profile within one complete revolution of the rotor in each case. For example, it can be provided that the asymmetrical arrangement of one stator pole, multiple stator poles, and/or all stator poles can be optimized by design, to effect a conversion of a rotational movement into a linear movement.

In a further embodiment of the stator, the first flank and/or the second flank is beveled in relation to the central axis of the stator over at least one height region of the first stator pole. The bevel is implemented in this case in a discrete or continuous curve or a combination of the two.

In one embodiment of the stator, in which both flanks of at least one stator pole are beveled, this bevel can be identical or different on both flanks. Furthermore, it can be provided that the bevel on the first flank and the bevel on the second flank results in a tapering of the stator pole with increasing proximity of the end side of the stator closest to the bevel. In another embodiment of the stator, it can be provided that the bevel on the first flank and the bevel on the second flank result in a widening of the stator pole with increasing proximity to the end side of the stator closer to the bevel. Furthermore, it may be possible for the width of the stator to remain constant in the direction perpendicular to the central axis of the stator, in spite of beveling on both flanks due to parallelism of the first flank and the second flank.

The advantage of a bevel of the first flank and/or the second flank of the first stator pole in relation to the central axis of the stator is, for example, that a detent torque which counteracts a movement of a rotor is reduced or even avoided, i.e., reduced to a value of nearly zero. When considering a bevel angle in relation to a plane containing the central axis of the stator, a bevel can be provided, in particular, as a bevel having bevel angles of less than 10°. In particular, it can be provided that the bevel angle is less than 5°. In a preferred embodiment, bevel angles of less than 2°, particularly preferably of approximately 0.9°-1.0° are provided.

In a further embodiment of the stator, it can be provided, for example, that the ratio of a height region provided with a bevel oriented along an axial direction to a total height oriented in an axial direction is 1.4.

In a further embodiment, it can be provided that stator poles provided with a bevel are regularly arranged alternately with stator poles not provided with a bevel on the stator.

Furthermore, it can be provided that one or more stator poles only have bevels on a single end side of the stator. In another embodiment, in contrast, it can be provided, for example, that the stator poles have bevels on both end sides of the stator.

In a further embodiment of the stator, at least one end-side sectional area of the first stator pole corresponds to at least one end-side sectional area of a hard magnetic region of the rotor.

In one embodiment of the stator, it can be provided that a corresponding end-side sectional area of the first stator pole is at least regionally identical to an end-side sectional area of a hard magnetic region of the rotor. In one specific embodiment, the end-side sectional area of the first stator pole is identical to at least one end-side sectional area of a hard magnetic region of the rotor, wherein identical is to be understood to mean largely congruent. The advantage of a largely congruent embodiment of an end-side sectional area of the first stator pole with an end-side sectional area of the hard magnetic region of the rotor is, for example, that the detent torque is reduced. A further advantage can be that in operation of an electrical machine having the stator, achievement of an ideal sinusoidal voltage curve is nearly attained, so that additional filtering of the voltage curve is no longer necessary.

For example, it can be provided that a sectional area of the first stator pole perpendicular to a longitudinal axis of the stator corresponds with at least one end-side sectional area of a hard magnetic region of the rotor, and that the sectional area halves an axial extension of the stator.

Furthermore, it can be provided, for example, that each stator pole of the stator corresponds with an end-side sectional area of a hard magnetic region of the rotor. It can be provided in this case that in addition to a correspondence of an end-side sectional area, the relative position of the stator poles of the stator in relation to one another also corresponds to the relative position of the hard magnetic regions in relation to one another.

In a further implementation of the stator, it can be provided that the density of the stator is set in a location-dependent manner to provide a set location-dependent magnetic resistance. In this way, even if an identical material is used, solely by changing the density of this identical material, the ferromagnetic permeability can be maintained and in this way the ferromagnetic resistance can be set directly. In turn, the result of setting the ferromagnetic resistance is that the curve of the ferromagnetic field lines inside the stator can be set, since this assumes a curve corresponding to the principle of energy minimization.

For example, it can be provided that if the stator is embodied as a stator made of a material having a theoretical density of 7.7 g cm⁻³, each stator has, on arithmetic average, a density of 7.5 g cm⁻³, while the region provided as the stator pole carrier has, on arithmetic average, a density of 7.2 g cm⁻³, wherein the density of a perfect imaginary single crystal of the soft magnetic material used is referred to as the theoretic density.

In a further implementation of the stator, it is provided that a region of the stator which at least partially encircles the central axis of the stator has a reduced height, in relation to at least one adjacent region adjoining this region, to at least partially accommodate at least one winding. For example, it can be provided that a circumferential groove is provided in a region between the central axis of the stator and the stator pole carrier. In particular, it can be provided that a partial circumferential groove or a complete circumferential groove is provided in a region between the stator poles and the stator pole carrier, so that space is made available, which is suitable for accommodating a winding, and this winding can then comprise the stator poles at least regionally and also the rotor, also at least regionally.

In a further implementation of the stator, it can be provided that the stator pole carrier at least regionally has at least one recess and/or at least one projection. In this case, it can be provided that the recess and/or the projection are preferably oriented essentially in a direction parallel to the central axis. These recesses and/or projection can be provided, for example, in the form of teeth, in the form of prongs, in the form of semicircles, in the form of ellipses, or else in combinations thereof or similar designs, and also any other arbitrary shape. Furthermore, it can be provided that the stator has at least one recess and/or at least one projection on only one end side, on another end side, or else often on both end sides. The recess and/or the projection can be arranged in this case in accordance with a provided arrangement of the stators. For example, with a provided arrangement of a front end side of a first stator with a rear end edge of another stator, the projections and/or recesses on the front end side of the one stator can accordingly be correspondingly arranged with corresponding recesses and/or projections on the rear end side of the other stator. Furthermore, an angular distribution or a spacing of the projections and/or recesses on one end side of one stator in each case can take place in accordance with a desired option for setting phase shifts.

In a further embodiment, the stator can be embodied, for example, insofar as at least the first stator pole and the second stator pole are connected to one another via at least one strut. In this case, the strut is arranged at least partially circumferentially around the central axis of the stator. The strut in this case has, at least sectionally, a taper in a direction essentially parallel to the central axis. In a further implementation of the stator, it can be provided that the strut is arranged essentially coaxially to and partially circumferentially around the central axis and/or wherein the strut, at least sectionally, has a density reduced in relation to adjacent regions of the strut.

One advantage of an at least sectional taper of the strut in a direction essentially parallel to the central axis is that an incorrect magnetic flux can be largely prevented or reduced nearly to zero. This is caused by the fact that due to the reduced height in the region of the taper, a magnetic saturation of the ferromagnetic material can be achieved more rapidly than in the regions of the stator adjacent to the taper. Due to the magnetic saturation, a ferromagnetic insulation arises as a result in the region of the taper, which separates the magnetic flux of two respectively adjacent stator poles from one another.

A comparable advantage is achieved by an at least sectionally reduced density of a strut in relation to adjacent regions of the strut. A reduced density corresponds in this case, with respect to the physically achieved defect, in a similar manner to the above-described taper of the strut. A combination of such a taper of the strut and a reduction of the density additionally results in a further amplification of the described effect.

Furthermore, in one embodiment of the stator, it can be provided that an angular distribution of the stator poles, an embodiment of the stator poles, and/or a distribution of the density of the stator poles is set in accordance with a desired torque curve in the course of a revolution of the rotor.

In a further embodiment of the stator, it is provided, for example, that the stator has nine stator poles. In one implementation of the stator, for example, it is provided that two adjacent stator poles are pivoted at an angle of (120/9)°, wherein a pivot at this angle is to be understood to mean that in the case of identical shape of these adjacent stator poles, the congruency thereof could be achieved by a rotation at an angle of (120/9)° about the central axis of the stator. In another embodiment, it can be provided that two adjacent stator poles are pivoted at an angle of (120/6)°. Furthermore, it can be provided in a further implementation that the stator has six stator poles.

In a further embodiment, it can be provided that the stator is produced by powder metallurgy from a soft magnetic material. In one embodiment of the stator, it can be provided that the stator is produced by powder metallurgy, i.e., at least also using a method of powder metallurgy.

The term soft magnetic material identifies in this case materials having low coercive field strengths. In this case, it can be provided that materials having a coercive field strength of less than 5000 A/m are considered to be soft magnetic materials. In particular, it can be provided in this case that materials having a coercive field strength of less than 1000 Nm are considered to be soft magnetic materials. The specified coercive field strengths refer in this case to the region desired to be soft magnetic in each case, i.e., optionally only the stator poles or regions of the stator poles, for example. Furthermore, the specified coercive field strengths relate to the properties of the finished component.

In particular, it can be provided that the stator is produced by powder metallurgy from a soft magnetic material, which has a coercive field strength of less than 1000 A/m at least in the finished state of the stator.

The advantage of a production by means of a powder metallurgy method is that narrow tolerances, in particular in the dimensional accuracy, are achieved, which is necessary for achieving the properties of the stator.

In particular, it can be possible in this case, for example, that the stator is produced from an SMC material. Furthermore, it can be provided, for example, that the stator is produced in one piece.

One advantage of a use of an SMC material for producing the stator is that the iron proportion of the stator can be reduced. Furthermore, as a result of the above-described production of the stator with high tolerances with respect to the dimensions, and the above-described production of the winding with high tolerances with respect to the dimensions and the possibility resulting therefrom for the spatial separation of the phases from one another, additional material to be used for insulating the winding from the stator can be omitted. A further advantage of utilizing SMC material for producing the stator is the potential for easy recyclability due to the excellent suitability of the materials made of non-sintered SMC material for separating the individual components.

In a further implementation of the method, it can be provided that an austenitic material is disposed at least regionally within a space located between two adjacent stator poles. In this case, for example, it can be provided that an austenitic CrNi steel is disposed inside a space located between two adjacent stator poles. Furthermore, it can be provided, for example, that a material having a reduced permeability in comparison to that of the stator poles is provided between two adjacent stator poles. In particular, it can be provided that regions having a material are provided between two adjacent stator poles, wherein the permeability within the region or over the volume of the region is set on average at a permeability of 50% or less of the permeability of the stator poles.

A further concept of the invention relates to an electrical machine, comprising at least one stator pair made of a first stator and a second stator. Furthermore, the electrical machine comprises at least one first rotor located in a cavity formed by the first stator and the second stator, and at least one metallic winding encircling the rotor at least in a region of a height of the rotor. In this case, the first stator and the second stator are positioned angularly relative to one another by at least one end-side projection and/or recess located in a stator pole carrier of the first stator in cooperation with corresponding end-side projections and/or recesses located in a stator pole carrier of the second stator.

In a further implementation of the electrical machine, it can be provided that a positioning element is arranged between the winding and the first stator and/or the winding and the second stator for the defined spacing of the winding from the first stator and/or the second stator. Furthermore, it can be provided that a positioning element is arranged between the winding and the first stator and/or the winding and the second stator for the defined setting of a minimum spacing between the first stator and the winding and/or the second stator and the winding.

Furthermore, it can be provided that the term metallic winding encircling the rotor is to be understood to mean that a winding is provided along a circumferential orientation identical to the provided rotational direction of the rotor. Furthermore, it can be provided that the term metallic winding encircling the rotor is to be understood to mean that a winding is provided along a circumferential orientation which is opposite to the provided rotational direction of the rotor.

In a further embodiment of the electrical machine, it is provided that a number of at least two stator pairs are arranged one after another, and the first stator pair and the second stator pair are positioned angularly in relation to one another by means of at least one end-side projection implemented as an external projection and/or as a recess implemented as an external recess located in a stator pole carrier of the first stator pair, in cooperation with corresponding end-side projections implemented as external projections and/or recesses implemented as external recesses in a stator pole carrier of the second stator pair, and wherein the angular positioning between the first stator pair and the second stator pair is selected in accordance with a desired phase shift.

The advantage of an arrangement of at least two stator poles one after another by means of projections implemented as external projections and/or recesses implemented as external recesses, which are attached on the end side, in cooperation with corresponding end-side projections implemented as external projections and/or recesses implemented as external recesses in a second stator pair, is that a desired phase shift can be set exactly such that an electronic phase shift is no longer necessary.

A further advantage of the use of stator pairs having an end-side projection implemented as an external projection and/or recess implemented as an external recess located in a stator pole carrier of a first stator, in cooperation with corresponding end-side projections implemented as external projections and/or recesses implemented as external recesses located in a stator pole carrier of the second stator, is that an angular positioning following arrangement one after the other is no longer necessary afterand, in this way, a substantially simplified assembly of the electrical machine can be achieved.

In a further implementation of the electrical machine, it can be provided that the number of at least two stator pairs comprises at least two identical stator pairs.

In one embodiment of the electrical machine having at least two identical stator pairs, wherein these two identical stator pairs each comprise two identical stators, it can be provided that the first and the second stator pairs are pivoted in relation to one another at the same angle as two adjacently arranged stator poles of each of these stators of the at least two identical stator pairs.

In a further embodiment of the electrical machine, it can be provided that the winding is embodied as a ring winding, is substantially free of insulation material, and/or the winding has virtually no winding heads. In a further implementation of the electrical machine, it can be provided, for example, that the winding is completely free of insulation material. In a further implementation of the electrical machine, it is provided that the winding has no winding heads.

One advantage of an embodiment of the electrical machine having a winding, which is substantially free of insulation material and/or has virtually no winding heads is that the power density of the electrical machine is increased. The advantage of an implementation of the electrical machine such that the winding has no winding head, is that the power density of the electrical machine is optimized. Furthermore, by optionally omitting the winding heads, which are generally at least nearly, in most cases completely, nonfunctional, the quantity of material to be used for them is reduced. Thus, in many cases, for example, copper or alloys having copper as an essential component are used as the material for the windings, so that the copper demand can be significantly reduced through an option of omitting winding heads.

The advantage of a geometrical simplification of the winding as a ring winding is that the manufacturing of the winding is substantially simplified. In particular, due to significantly larger traction forces, which are possible during a production of the winding, it is possible to significantly increase the degree of filling of the winding as a whole. It is thus possible, for example, to achieve a degree of filling of approximately up to 90%, so that approximately up to 90% of the volume of the winding actually consists of the material used for the winding, and only a correspondingly lower volume proportion of the winding is nonfunctional. The advantage of the high degree of filling is, for example, that a structural size reduction of the winding and, as a result, of the electrical machine and, as a direct consequence, a substantial increase of the power density and/or, in an embodiment of the electrical machine as a direct-current machine, enable a utilization of currents having substantially higher current strength, than is the case with conventional winding technology in which winding heads appear.

In a further implementation of the electrical machine, it is provided that the first stator and the second stator have an identical design.

The advantage of an embodiment of the first stator and the second stator, such that the first stator and the second stator have an identical design, is that the number of different parts to be produced is reduced, and in this way the manufacturing method for production of the stators for electrical machines can be significantly simplified. Furthermore, a significant simplification of the manufacturing process is provided, in particular during the assembly of the electrical machine.

A further concept of the invention provides a method for assembling a preferably tubular electrical machine by means of at least one assembly of a stator pair. The method for assembling a tubular electrical machine by means of at least one assembly of a stator pair is performed in this case by performing at least the following steps:
positioning a rotor in a cavity of a first stator,
positioning a metallic winding in a region having a height reduced in relation to adjacent regions of the first stator, wherein the metallic winding encircles, preferably essentially coaxially, the region provided for the rotor at least over an axial region,
positioning the first stator at least in a form fit with the second stator, wherein in this case a defined angular positioning of the first stator and the second stator in relation to one another takes place by moving at least one projection and/or recess located on an end side in a stator pole carrier of the first stator into corresponding position with, in each case, one recess and/or projection located in an end side in a stator pole carrier of the second stator.

In one implementation of the method, it is provided that at least one first stator pair and one second stator pair are positioned one after another at least in a form fit. In this case, a defined angular positioning of the first stator pair and the second stator pair takes place by moving at least one projection implemented as an external projection and/or recess implemented as an external recess located on an end side in a stator pole carrier of the first stator into corresponding position with, in each case, one recess implemented as an external recess and/or one projection implemented as an external projection located in an end side in a stator pole carrier of the second stator.

In a further implementation of the method, it can be provided that the winding is wound prior to the positioning.

Positioning a metallic winding in a region having reduced height in relation to adjacent regions of the first stator, wherein the metallic winding is wound prior to the positioning, achieves the advantage that the phase angle, which typically has a longitudinal direction along an axial direction of a previously completed winding, no longer plays a role. As a result, complex winding technology, for example, needle winding technology and/or flyer winding technology, is no longer necessary. Furthermore, because of the now simplified usable winding technology, a significantly higher degree of filling of the material used for the winding is achievable. While in conventional techniques, such a degree of filling typically having values between approximately 40% and 50% is achievable, in the method claimed herein, the possibility exists of achieving a degree of filling of material used for the winding which is substantially higher and can reach up to 90%. Furthermore, because winding heads are no longer required, it is possible that wire protection is no longer necessary on the outer edges of the winding.

Furthermore, a further concept of the invention relates to a use of a method for assembling a tubular electrical machine for the scaled construction of an electrical machine using a stator. Preferably, an implementation of the electrical machine and/or the stator according to the above explanations is used for this purpose. In one implementation, the use is utilized for the construction of a transverse flux generator. In a further implementation, it is provided that the use is utilized for the construction of a transverse flux motor.

For example, a scaled construction of an electrical machine can be achieved by using identical stator pairs and/or identical stators. In the case of a construction of an electrical machine by arranging stator pairs one after another in an arbitrary number, for example, the length of the electrical machine can be selected arbitrarily in accordance with a desired power, the radial layouts or, in contrast, if circular-cylindrical stators are used, the diameter of the electrical machine remains unchanged.

Further advantageous embodiments and refinements result from the following figures. The details and features resulting from the individual figures are not restricted to the respective figure, however. Rather, one or more features can be linked with one or more features from different figures, and also with features resulting from the above description, to form new embodiments. In particular, the following statements do not serve to limit the respective scope of protection, but rather explain individual features and their possible interaction with one another.

### LIST OF REFERENCE SIGNS

1 stator
1′ first stator
1″ second stator
2 breakthrough
3 stator pole carrier
4 first stator pole
5 first flank
6 second flank
7 second stator pole
8′, 8″ further stator poles
9 central axis
10 height region
11 strut
12 taper
13 top end side
14 recess
15 projection
16 rotor
17 winding
18 first curvature line
19 second curvature line
20 third curvature line
21 electrical machine
22 hard magnetic region
23 complementary angle to the bevel angle
24 recess implemented as external recess
25 projection implemented as external projection

In the figures:

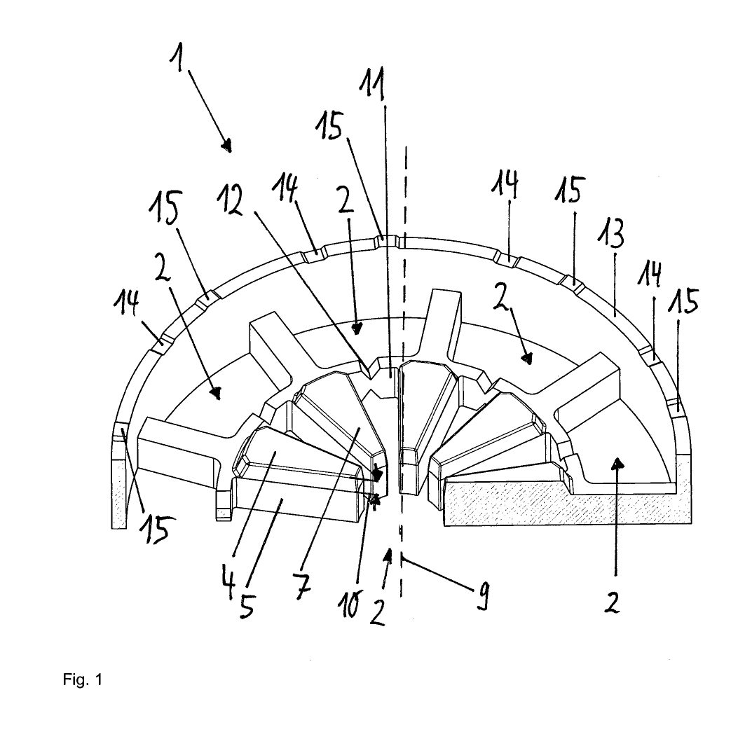

FIG. 1 shows a view of an embodiment of a stator in a section along a plane containing a central axis of the stator,

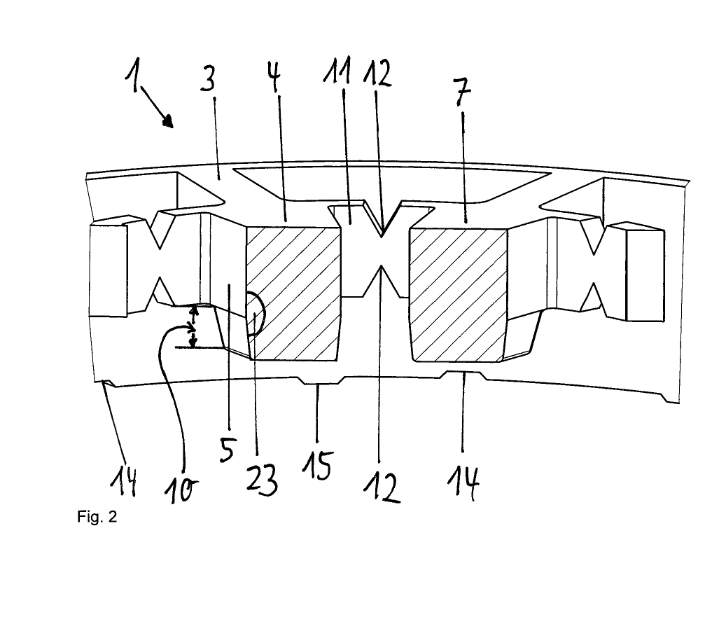

FIG. 2 shows a detail of a region of the stator shown in FIG. 1 in a section,

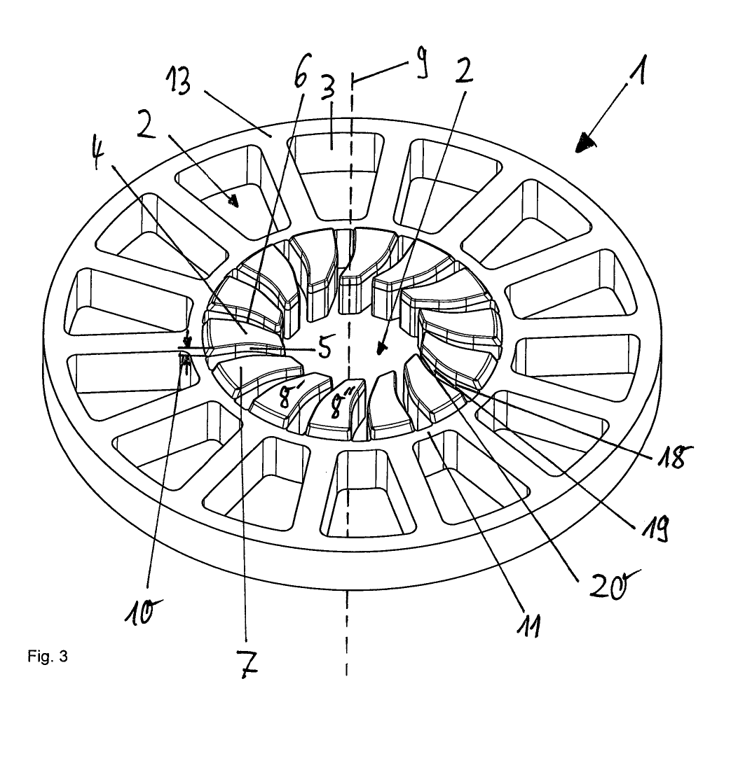

FIG. 3 shows a diagonal view of an embodiment of the stator having stator poles curved in relation to a plane containing each central axis of the stator,

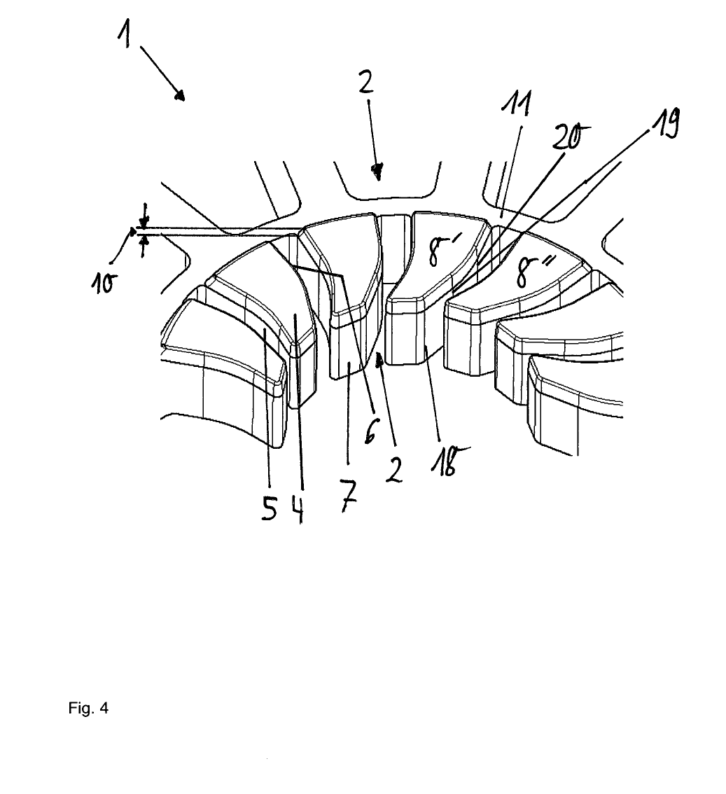

FIG. 4 shows a detail view of the stator shown in FIG. 3,

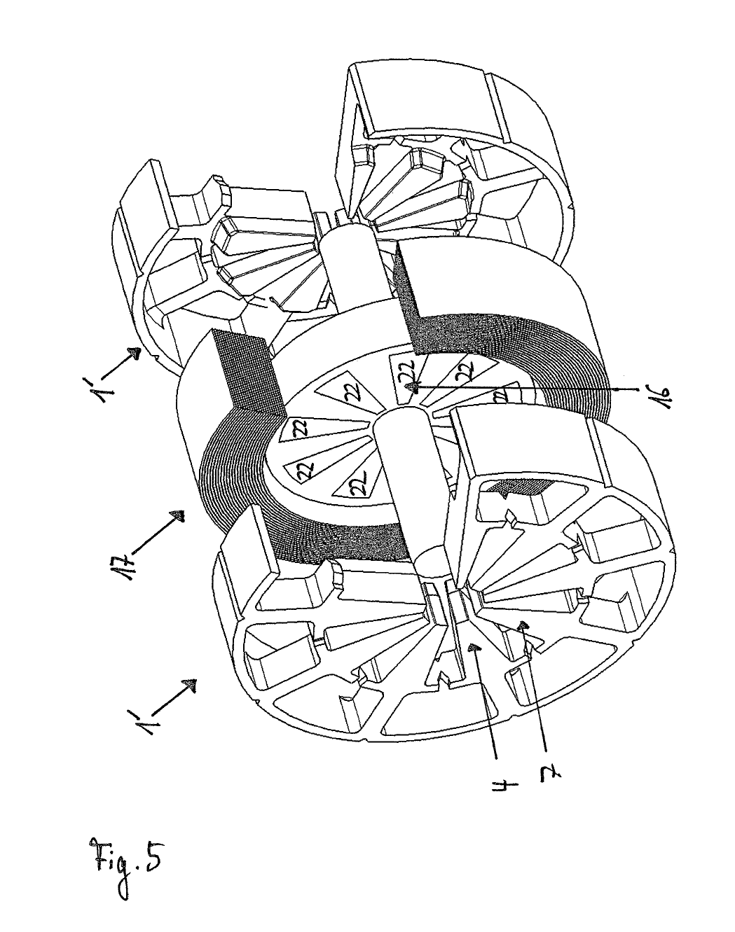

FIG. 5 shows an exploded view of an electrical machine made of a stator pair, a rotor, and a winding,

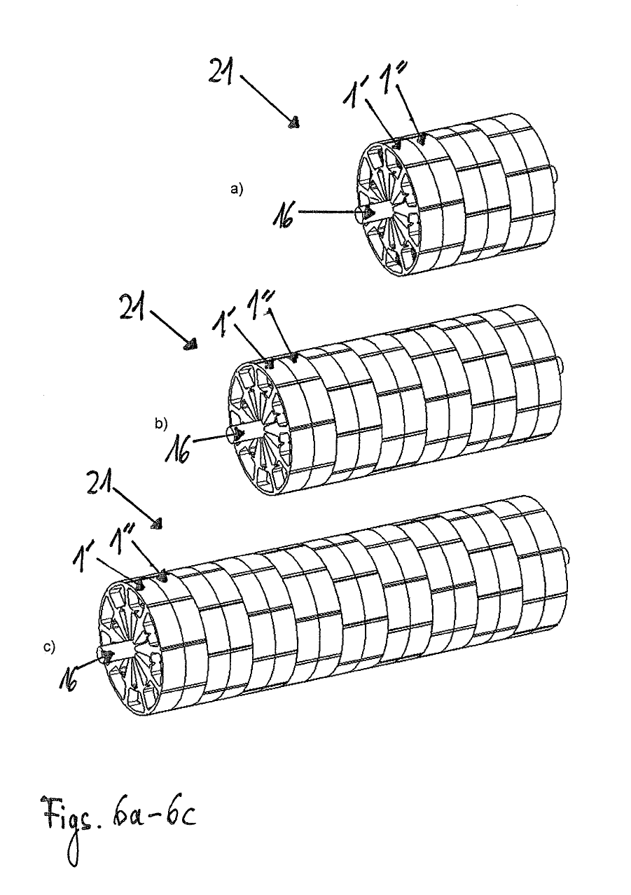

FIGS. 6a-c shows an illustration of various electrical machines in the embodiment of a tubular electrical machine in each case:
a) a tubular electrical machine comprising three stator pairs,
b) a tubular electrical machine comprising six stator pairs,
c) a tubular electrical machine comprising nine stator pairs,

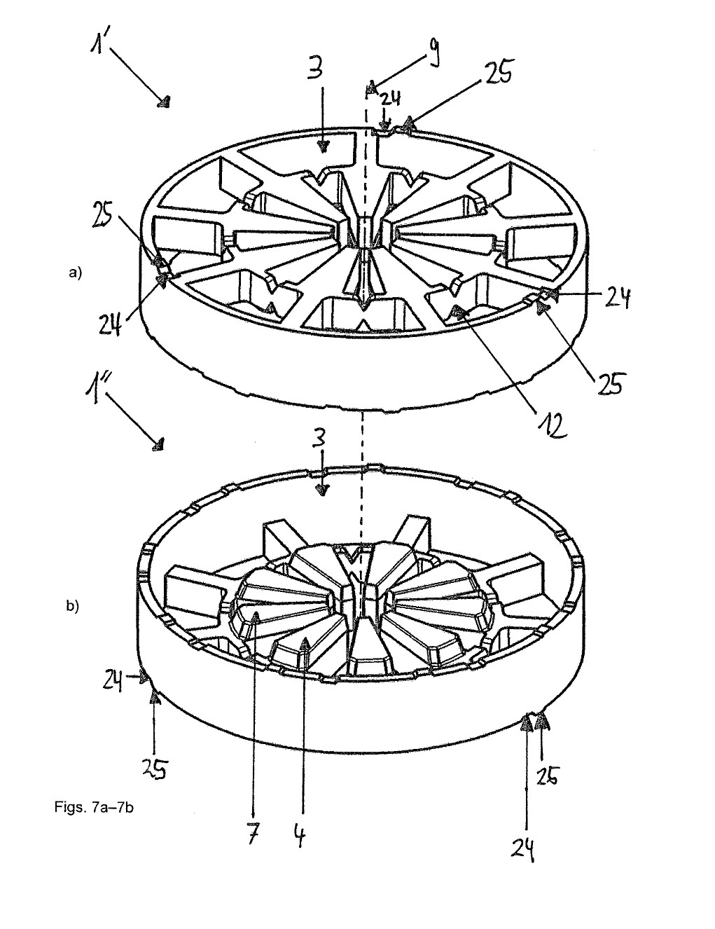

FIGS. 7a-b show a first stator and a second stator.

FIG. 1 shows a view of a stator 1 in a section along a plane, which contains the central axis 9 of the stator 1. In the embodiment shown, the stator 1 is implemented as a disk-like body provided with breakthroughs 2. The stator 1 has a region implemented as a stator pole carrier 3, which, in the exemplary embodiment shown, simultaneously also comprises an external circumference of the jacket of the stator 1. In the embodiment shown, the external circumference of the jacket of the stator 1 essentially describes a circular surface, so that the central axis 9 of the stator 1 intersects the center point of the circle and is coincident with the rotational axis of a rotor 16 of the electrical machine. Proceeding from an inner surface of the stator pole carrier 3, a first stator pole 4 having a first flank 5 and a second flank 6 (not visible in the illustration shown) and a second stator pole 7 are arranged jointly with further stator poles 8′, 8″ on the stator pole carrier 3. All stator poles are arranged in a regular arrangement in the embodiment of the stator 1 shown, while the angles between the planes of symmetry of adjacent stator poles, which comprise the central axis 9, are each identical. The stator poles are oriented pointing away in the direction of the central axis 9. It can be inferred from the implementation shown that both the first flank 5 and also the second flank 6 of the first stator pole 4 are beveled in a height region 10, wherein the bevel extends outward from the upper top side, when viewed in the orientation shown. The bevels are designed in the embodiment shown as inclined planes, which merge into the non-beveled planes of the respective flank with a discrete transition. In the embodiment shown, the stator poles are implemented identically and differ only in their orientation. The first stator pole, the second stator pole, and also the remaining stator poles are each plane-symmetrical to precisely one plane containing the central axis of the stator, i.e., they have no curvature. In the embodiment shown, the stator poles therefore do not have a curve deviating from a plane-symmetrical embodiment. As can furthermore be inferred from FIG. 1, in the embodiment of the stator shown, one strut 11, which partially encircles the central axis 9 in a coaxial orbit, is arranged in each case between two stator poles, respectively. The struts 11 shown each have a taper 12. Arranged on the top end side 13 of the stator pole carrier are recesses 14, on the one hand, and projections 15, on the other hand, wherein recesses 14 and projections 15 are each arranged alternately following a curve encircling the central axis 9. Identically implemented recesses 14 and projections 15 are also arranged on the opposite end side; however, these cannot be seen in the view shown.

FIG. 2 shows a detail of a region of the stator shown in FIG. 1 in a section. The section extends in this case in a plane perpendicular to the symmetry plane of the middle of the three stator poles shown. In addition to a more detailed view of the recognizable features already shown in FIG. 1, the complementary angle 23 to the bevel angle also be seen in FIG. 2 in a corresponding perspective view. The bevel angle in the embodiment of the stator shown here is 0.9° at all stator poles and in each case on both flanks of the stator poles, so that the complementary angle 23 is accordingly 179.1°.

The implementation of a stator 1 shown in FIG. 3 differs from the implementation of a stator 1 shown in FIG. 1, inter alia, in that the first stator pole 4, the second stator pole 7, and also all other stator poles are curved. As a result, the stator poles are asymmetrical in relation to each axis containing the central axis 9. In this case, the stator pole curves essentially progressively away from this plane with increasing distance of a respective stator pole of the stator carrier 3. The curvature of the stator poles is not continuously developing in this case in the implementation shown, but rather is embodied discretely on a first curvature line 18, a second curvature line 19, and a third curvature line 20. Further in contrast to the implementation shown in FIG. 1, the stator does not have a taper 12 of the strut 11 in the implementation shown in FIG. 3.

FIG. 4 shows a detail from FIG. 3 for clarification in enlarged form.

FIG. 5 shows an electrical machine 21 made of a stator pair consisting of a first stator 1′ and a second stator 1″, a rotor 16, and a winding 17 in an exploded view. A cavity is formed by the first stator 1′ and the second stator 1″, which is used, on the one hand, to accommodate the rotor 16 and, on the other hand, to accommodate the winding 17. The first stator 1′ and the second stator 1″ are constructed in this case similarly to the stator shown in FIG. 1. In the region between the struts 11 and the stator pole carrier 3, along a direction parallel to the axial direction, the height is reduced around the complete circumference of the central axis 9 in relation to the adjacent regions, which are implemented here as the struts 11 and as the stator pole carrier 3. The reduced height is implemented in the exemplary embodiment shown in this case as a groove around the complete circumference of the central axis 9 of the stator 1. The resulting cavity is used to accommodate the winding 17, the extension of which in a direction parallel to the axial direction protrudes beyond the extension of the rotor 16. Furthermore, it can be seen in FIG. 5 that the first stator pole 4, the second stator pole 7, and the remaining stator poles (not provided with reference signs) correspond in the region of their extension in an end-side section with the hard magnetic regions 22. The correspondence is implemented in this case such that the areas in the end-side section are regionally congruent. This congruency of the areas of the stator poles in the end-side section with the areas of the hard magnetic regions in combination with the bevel of the first flank 5 and the second flank 6 of the first stator pole 4 and, in a similar manner, the flanks of the remaining stator poles results, during operation of the electrical machine, in the generation of a nearly perfect sinusoidal voltage curve.

FIG. 6 shows various electrical machines 21 made of a number of stator pairs in an assembled state. FIG. 6a) shows an electrical machine 21 made of three stator pairs having a first stator pair made of a first stator 1′ and a second stator 1″ and correspondingly two further stators. The stator pairs are pivoted in this case in relation to one another in accordance with a desired phase shift. FIG. 6b shows an electrical machine 21 made of six stator pairs, wherein the implementation shown of the electrical machine 21 is implemented by arranging the implementation of the electrical machine shown in FIG. 6a) one after another. In a similar manner, an implementation of an electrical machine 21 made of three stator pairs, as are shown in FIG. 6a), arranged one after another is shown in FIG. 6c). The three examples shown in FIG. 6 therefore demonstrate how a scaled construction of an electrical machine 21 is enabled by arranging stator pairs one after another.

FIG. 7a and FIG. 7b show two stators, a first stator 1′ and a second stator 1″, which are similar to the stator shown in FIG. 1. The reference signs therefore correspond to the explanations shown under FIG. 1. The stators shown in FIG. 7a and FIG. 7b are identical in their shape. On their two sides facing away, both stators each have three pairs of recesses and projections, which are implemented as the external recess 24 and external projection. After joining the first stator 1′ shown in FIG. 7a with the second stator 1″ shown in FIG. 7b, the pair then resulting having the pairs of external recess 24 and external projection 25 can then be joined in each case in at least also form fitting connection with identical stator pairs. Because of the arrangement of pairs of external recess 24 and external projection 25, which are rotationally oriented to one another at an angle of (360/3)°, and the embodiment shown in this example of the stators as stators having 9 stator poles in each case, which are arranged with an alignment rotationally oriented at (360/9)° to one another, an arbitrary possible arrangement of stators in each case results in the example shown in a desired angular orientation of the stators of a stator pair, on the one hand, and multiple stator pairs to one another, on the other hand.

1. A stator for an electrical machine which can be assembled, preferably reversibly, having at least one rotor, wherein the stator is implemented as a body provided with at least one breakthrough, which comprises at least one ferromagnetic material, and wherein the stator furthermore comprises:
at least one region implemented as a stator pole carrier, which at least partially encircles a central axis of the stator,
at least one first stator pole having at least one first flank and one second flank, and
at least one second stator pole,
wherein the stator poles, preferably oriented pointing essentially along a radial direction, are arranged directly or indirectly on the stator pole carrier.

2. The stator according to claim 1, characterized in that the first stator pole is asymmetrical to each plane containing the central axis of the stator and is curved essentially progressively away from this plane with increasing distance from the stator pole carrier.

3. The stator according to claim 1, characterized in that the first flank and/or the second flank is beveled over at least one height region of the first stator pole in relation to the central axis of the stator, wherein the bevel is implemented in a discrete or continuous curve or a combination of both.

4. The stator according to claim 1, characterized in that the first stator pole having the at least one end-side sectional area corresponds to at least one end-side sectional area of a hard magnetic region of the rotor.

5. The stator according to claim 1, characterized in that the density of the stator is set in a location-dependent manner to provide a magnetic resistance set in a location-dependent manner.

6. The stator according to claim 1, characterized in that a region of the stator at least partially encircling the central axis has a height reduced in relation to at least one adjacent region adjoining this region to at least partially accommodate at least one winding.

7. The stator according to claim 1, characterized in that the stator carrier of the stator at least regionally has at least one recess, which is preferably oriented essentially in a direction parallel to the central axis, and/or at least one projection, which is preferably oriented in a direction essentially parallel to the central axis.

8. The stator according to claim 1, characterized in that at least the first stator pole and the second stator pole are connected to one another via at least one strut, and the strut is arranged at least partially circumferentially around the central axis of the stator, preferably essentially coaxially, and wherein the strut has a taper at least sectionally in a direction essentially parallel to the central axis and/or wherein the strut at least sectionally has a density reduced in relation to adjacent regions of the strut.

9. The stator according to claim 1, characterized in that an angular distribution of the stator poles, an embodiment of the stator poles, and/or a distribution of the density of the stator poles is set in accordance with a desired torque curve during the course of a revolution of the rotor.

10. The stator according to claim 1, characterized in that the stator is produced by powder metallurgy from a soft magnetic material, preferably from an SMC material, preferably in one piece.

11. The stator according to claim 1, characterized in that an austenitic material, preferably an austenitic CrNi steel, is disposed at least regionally within a space located between two adjacent stator poles.

12. An electrical machine, comprising at least one stator pair made of a first stator and a second stator, preferably each according to claim 1, at least one first rotor located in a cavity formed by the first stator and the second stator, at least one metallic winding, which encircles the rotor at least in a region of a height of the rotor, wherein the first stator and the second stator are positioned angularly in relation to one another by means of at least one projection and/or recess located in an end side in a stator pole carrier of the first stator in cooperation with corresponding projections and/or recesses located in an end side in a stator pole carrier of the second stator.

13. The electrical machine according to claim 12, characterized in that a number of at least two, preferably two identical stator pairs are arranged one after another, and wherein the first stator pair and the second stator pair are positioned angularly in relation to one another by means of at least one projection, implemented as an external projection, and/or a recess, implemented as an external recess, located on an end side in a stator pole carrier the first stator pair in cooperation with corresponding projections implemented as external projections and/or recesses implemented as external recesses located on an end side in a stator pole carrier of the second stator pair, and wherein the angular positioning between the first stator pair and the second stator pair is selected in accordance with a desired phase shift.

14. The electrical machine according to claim 12, characterized in that the winding is embodied in a ring winding, largely, preferably completely, free of insulation material, and/or the winding has virtually no, preferably no winding heads.

15. The electrical machine according to claim 12, wherein the first stator and the second stator have an identical design.

16. A method for assembling a preferably tubular electrical machine by means of at least one assembly of a stator pair, by completing at least the following steps:
positioning a rotor in a cavity of a first stator,
positioning a metallic winding in a region having reduced height in relation to adjacent regions of the first stator, wherein the metallic winding encircles, preferably essentially coaxially, the region provided for the rotor at least over an axial region,
positioning the first stator at least in a form fit with the second stator, wherein in this case a defined angular positioning of the first stator and the second stator in relation to one another takes place, in that at least one projection and/or recess located on an end side in a stator pole carrier of the first stator is moved into corresponding position with, in each case, a recess and/or projection located on an end side in a stator pole carrier of the second stator.

17. The method according to claim 16, wherein at least one first stator pair and one second stator pair are positioned at least in a form fit one after another, wherein in this case a defined angular positioning of the first stator pair and the second stator pair takes place, while at least one projection, implemented as an external projection, and/or recess, implemented as an external recess, located on an end side in a stator pole carrier of the first stator is moved into corresponding position with, in each case, a recess, implemented as an external recess, and/or a projection, implemented as an external projection, located on an end side in a stator pole carrier of the second stator.

18. The method according to claim 16, characterized in that the winding is wound prior to the positioning.

19. A use of a method according to claim 16 for the scaled construction of an electrical machine according to claim 12, using a stator according to claim 1.
